(19) United States
(12) Patent Application Publication
(10) Pub. No.: US 2026/0058593 A1
(43) Pub. Date: Feb. 26, 2026

(54) COMPRESSOR MODULE, COMPRESSED-AIR SUPPLY SYSTEM, METHOD FOR OPERATING A COMPRESSOR MODULE OR A COMPRESSED-AIR SUPPLY SYSTEM

(71) Applicant: ZF CV Systems Europe BV, Brussels (BE)

(72) Inventors: Uwe Stabenow, Laatzen (DE); Jörg Meier, Hessisch Oldendorf (DE); Matthias Hahn, Barsinghausen (DE)

(21) Appl. No.: 19/379,592

(22) Filed: Nov. 4, 2025

Related U.S. Application Data
(63) Continuation of application No. PCT/EP2024/061316, filed on Apr. 24, 2024.

(30) Foreign Application Priority Data
May 9, 2023 (DE) 10 2023 112 175.8

(51) Int. Cl. H02P 29/032; B60G 11/27; B60G 11/30; B60G 17/052; B60T 13/26; B60T 13/68; B60T 17/02; F15B 15/18; G05D 16/20

(52) U.S. Cl. CPC H02P 29/032; F15B 15/18; G05D 16/2066; B60G 11/27; B60G 11/30; B60G 17/0525; B60G 2202/152; B60G 2202/42; B60G 2500/205; B60G 2800/914; B60T 13/268; B60T 13/683; B60T 17/02

(57) ABSTRACT

A compressor module, in particular for a compressed-air supply system of a vehicle, is connected to or has an electronic control unit. The control unit is configured to specify the target speed as a function of a motor current currently drawn by the speed-controlled brushless electric motor and a specified maximum motor current such that the target speed corresponds to a specified constant speed as long as the motor current currently drawn by the speed-controlled brushless electric motor is lower than the specified maximum motor current and the target speed is adjusted such that the motor current currently drawn by the speed-controlled brushless electric motor corresponds to the specified maximum motor current as long as the motor current currently drawn by the speed-controlled brushless electric motor corresponds at least approximately, that is, within the scope of the control or adjustment precision, to the specified maximum motor current.

### CROSS-REFERENCE TO RELATED APPLICATIONS

This application is a continuation application of international patent application PCT/EP2024/061316, filed Apr. 24, 2024 designating the United States and claiming priority from German application 10 2023 112 175.8, filed May 9, 2023, and the entire content of both applications is incorporated herein by reference.

### TECHNICAL FIELD

The disclosure relates to a compressor module, in particular for a compressed-air supply system for a vehicle. The disclosure also relates to a compressed-air supply system and to a method for operating a compressor module or a compressed-air supply system.

### BACKGROUND

In motor vehicles, compressed-air supply systems can supply compressed air to, for example, an air spring system as a compressed-air consumer and/or a pneumatic brake system as a compressed-air consumer. In order to be able to supply compressed air at a sufficiently high pressure for compressed-air consumers of this kind, compressing devices or compressors are required for generating compressed air. Compressing devices or compressors of this kind are typically driven by electric motors which draw a motor current during operation. Compressing devices or compressors are used as synonyms in the present description and refer to assemblies which compress air. A compressing device or compressor can be combined with a driving electric motor to form a compressor module as one structural unit.

Essential constituent parts of a compressed-air supply system, in addition to the compressed-air consumer or the compressed-air consumers and the compressor or compressing device and its drive, are electrically controllable valves which can be controlled—that is, for example opened or closed—by a compressed-air controller. In this way, compressed air can be supplied to the individual compressed-air consumers of a compressed-air supply system in a targeted manner or else compressed air can be discharged. Depending on which compressed-air consumers have to be supplied with compressed air during the particular operating situation, the compressor work to be performed by the compressor can vary greatly. As explained in further detail below, the torque to be delivered by the drive of the compressor or compressing device depends on the pressure that the compressed air has to be at for the particular operating situation. If the compressor or compressing device is driven by an electric motor, the current consumption by the electric motor depends on the torque to be delivered (that is, the operating load of the drive) at the supply voltage typically provided by the on-board electrical system of a vehicle.

The compressing device or compressor and the associated drive, in particular the associated electric motor, are preferably combined in one structural unit-referred to as compressor module below. Compressor modules are used, for example, for compressed-air supply systems of motor vehicles.

Electric motors used for driving compressors or compressing devices are preferably brushless direct-current motors (BLDC motors: brushless direct-current motors). A brushless direct-current motor, as a so-called internal rotor motor, typically has a stator fitted with electromagnetic coils—that is, to a coil-wound stator—, a rotor fitted with permanent magnets, and a motor electronics system. The motor electronics system is configured as an electronic commutator in such a way that the motor electronics system controls the current supply to the coils of the stator (also referred to as stator coils below) via circuit breakers such that the stator coils are in turn periodically supplied with current in such a way that a rotating magnetic field is produced, this causing synchronous rotation of the rotor fitted with permanent magnets due to magnetic forces. Brushless direct-current motors of this kind with rotors fitted with permanent magnets are therefore also referred to as PMSM motors, where PMSM stands for permanent magnet synchronous motor. The abbreviation PMSM is typically used for sine-commutated brushless electric motors, while the abbreviation BLDC (brushless direct-current) is usually used for block-commutated brushless electric motors. In block commutation, the energization of the (for example three or n times three) stator coils is digitally switched over, that is, either no current or full current is applied to the windings of the respective stator coil or stator coils of a phase. In sine commutation, each stator coil of the motor is energized with a sine curve offset by 120°, this resulting in a continuously rotating stator magnetic field of constant strength.

For speed control known per se of a brushless electric motor, the electric motor has means for rotor angle detection which have electronic sensors, such as Hall sensors for example, for detecting the rotor position. This also allows a phase angle between the applied rotating field and the mechanical rotation of the rotor to be detected and the phase angle of the rotating field to be correspondingly adjusted. BLDC motors therefore behave similarly to mechanically commutated direct-current motors. However, brushless direct-current motors are more efficient and subject to less wear and their speed can be controlled better than electric motors with a brush commutator.

In compressor modules for generating compressed air in a compressed-air supply system, for example for motor vehicles, the compressor generating the compressed air and its electric motor serving as a drive form one structural unit. For both efficient and environmentally friendly operation, the configuration and operation of the electric motor—that is, the brushless direct-current motor—pose a particular challenge. This includes, amongst other things, the compressor module being able to provide a sufficient amount of compressed air in the respective compressed-air supply system at any time in the various possible operating situations-even the rare ones. This means that a compressor module has to provide a sufficient amount of compressed air for the compressed-air supply system even under unfavorable conditions that occur only rarely (worst-case operating situation). For this purpose, the drive, that is, the preferably brushless direct-current motor for example, also has to be configured in a corresponding manner. At a given supply voltage of the direct-current motor, a higher mechanical load—that is, a higher mechanical output power—inevitably leads to a greater current consumption by the direct-current motor. However, in order to protect the on-board electrical system of a motor vehicle, the maximum current consumption by a direct-current motor has to be limited.

WO 2020/225024 A1 discloses operating a BLDC motor for driving a compressor at a constant speed and reducing this speed depending on the load conditions operating voltage and load (torque) in order to avoid overdimensioning the motor.

### SUMMARY

It is an object of the disclosure to ensure reliable and environmentally friendly operation of a compressor module in the simplest possible way.

The disclosure proposes a compressor module, in particular a compressor module for a compressed-air supply system, in particular for a motor vehicle, in order to achieve this object, the compressor module having at least the following components:
a compressor and
a speed-controlled brushless electric motor for driving the compressor, a motor current being produced during operation of the electric motor and a motor electronics system with an electronic commutator and a speed controller being assigned to the electric motor, wherein the speed is controlled on the basis of a specified target speed during operation.

The compressor module is connected to or has an electronic control unit. The electronic control unit can be provided separately or can be a constituent part of the motor electronics system and according to the disclosure is configured to specify the target speed as a function of a motor current currently drawn by the speed-controlled brushless electric motor and a specified maximum motor current in such a way that
the target speed corresponds to a specified constant speed as long as the motor current currently drawn by the speed-controlled brushless electric motor is lower than the specified maximum motor current (that is, nₛₒₗₗ=n_{const} when I_{B}<I_{B max}) and
the target speed is adjusted in such a way that the motor current currently drawn by the speed-controlled brushless electric motor corresponds to the specified maximum motor current as long as the motor current currently drawn by the speed-controlled brushless electric motor corresponds at least approximately—that is, within the scope of control or adjustment precision—to the specified maximum motor current (n_{variable} when I_{B}=I_{B max}). Here, the variable target speed is lower than the specified constant speed.

This means that the drive motor of the compressor module, that is, the brushless electric motor, is operated at the constant speed—or at a specified constant speed from amongst several possible constant speeds—as the target speed (nₛₒₗₗ=n_{const}) as long as the current motor current I_{B} is lower than the specified maximum motor current. As soon as the value for the current intensity of the current motor current reaches or exceeds the specified maximum motor current, the current is limited, which results in the speed of the brushless electric motor decreasing, so that the load, that is, the torque to be delivered by the brushless electric motor, is so high that the specified maximum motor current I_{B max} is not exceeded because increasing counterpressure on the pressure side of the compressor leads to an increasing torque and thus to an increasing motor current at a constant speed and the torque and thus the motor current can be kept constant at a speed that decreases in accordance with the increasing counterpressure.

The brushless electric motor is preferably speed-controlled.

A specified target speed for the brushless electric motor is preferably constant as long as the currently drawn mean motor current IB is lower than or equal to the specified maximum motor current. The target speed then corresponds to a specified speed-possibly one of several specified speeds.

The speed of the brushless electric motor is preferably continuously adjusted in a load-dependent manner in accordance with a specified characteristic curve or a given characteristic diagram when the currently drawn mean motor current I_{B} reaches the specified maximum motor current. Since the load, that is, the torque to be applied by the brushless electric motor, depends on the pressure at the output of the compressor, characteristic curve control can be configured in such a way that it supplies a target speed value (also referred to here as the target speed) as the output value for a pressure as the input value. If characteristic diagram control is provided for the target speed, this characteristic diagram control can be specified a target speed as a function of several input parameter values. In addition to values for the pressure in the compressed-air supply system, input parameter values can also be, for example, values for the parameters geodetic height and/or the outside air temperature since the air density and thus also the air masses to be conveyed depend on these parameters.

In an alternative embodiment, the brushless electric motor is current-controlled when the currently drawn mean motor current I_{B} reaches the specified maximum motor current I_{B max} and would exceed it at a constant speed. The target value for the motor current Iₛₒₗₗ is then I_{B max}. This means that the brushless electric motor always outputs its maximum possible power without the mean motor current I_{B} exceeding the maximum motor current I_{B max}—with the exception of slight exceedances within the scope of control precision. The brushless electric motor is current-controlled as long as the current speed ng of the brushless electric motor is lower than the specified constant speed (I_{B}=I_{B max} as long as n_{B}<n_{const}).

The motor current used for controlling the speed is preferably a mean motor current, which is time-averaged and/or low-pass filtered in order to compensate for cyclical fluctuations in the motor current or short-term peaks in the motor current.

Control of the target speed in one case (I_{B}<I_{B max}) as well as control of the motor current in the other case (n_{B}<n_{const}) can be continuous, time-discrete or else quasi-continuous.

The compressor module is preferably a constituent part of a compressed-air supply system, in particular a compressed-air supply system for a motor vehicle. A further aspect of the disclosure thus relates to a compressed-air supply system, in particular a compressed-air supply system for a motor vehicle, including
one or more compressed-air consumers,
compressed-air lines,
electrically controllable valves,
a compressed-air controller for actuating the electrically controllable valves,
a compressor module of the abovementioned type including a compressor or compressing device and a brushless electric motor as the drive, and
preferably a pressure reservoir.

In a configuration variant with a compressed-air reservoir, the compressed-air consumer or consumers is/are or can be pneumatically connected to the compressor or compressing device and/or the pressure reservoir via the compressed-air lines and the electrically controllable valves in such a way that the compressed-air supply system can be operated either in an open operating mode or in a closed operating mode.

In a compressed-air supply system of this kind, the work to be performed by the compressor module—that is, the torque to be output—can be reduced by, for example, changing from the closed to the open operating mode. This allows the specified constant speed to be maintained for longer under certain circumstances. In this respect, control of the brushless electric motor can be combined with switchover of the operating mode.

The compressed-air controller preferably has a current signal input, which is connected to at least one current sensor, which is configured to detect a motor current drawn by the electric motor driving the compressor or compressing device and to output a signal representative of this motor current to the compressed-air controller. The current sensors used may be the current sensors of the motor electronics system that are usually provided for each phase. A mean motor current can already be formed by the motor electronics system on the compressor module or by the compressed-air controller. For example, the motor electronics system can determine the mean motor current from the three measured phase currents. As an alternative, an additional current sensor could also be provided.

The control signals to be output by the compressed-air controller can be, for example, a target speed for a speed controller of the electric motor or control signals for activating or deactivating valves of the compressed-air supply system in accordance with an open or closed operating mode.

In order to specify a constant speed as the target speed for the brushless electric motor as long as the mean motor current is lower than the maximum motor current, the compressed-air controller can be connected to a target speed data memory in which several specified speed values are stored. The specified fixed number of speeds is advantageous in order to improve the acoustic behavior. These speeds can be set to operating points which have good acoustic and/or pneumatic performance.

A characteristic curve memory or a characteristic diagram memory is preferably provided for characteristic curve control or characteristic diagram control of the speed in the case in which the mean motor current would exceed the maximum motor current at a specified constant speed.

The compressed-air controller can be configured
to evaluate a current signal, the value of which represents the value of the current motor current I_{B}, and, in the event that the current motor current reaches the specified maximum motor current, to determine a reduced target speed value in such a way that the mean motor current drawn by the brushless electric motor driving the compressor or compressing device does not exceed the maximum motor current, but rather corresponds to the maximum motor current within the scope of control precision.

The compressed-air controller is preferably configured
to evaluate a current signal, the value of which represents the value of the current motor current I_{B}, and, in the event that the current mean motor current reaches the specified maximum motor current, to determine a reduced target speed value as a function of a pressure measured in the compressed-air supply system based on a stored characteristic curve or a stored characteristic diagram.

In addition, the compressed-air controller can be configured
either to actuate the electrically controllable valves in accordance with the open operating mode of the compressed-air supply system when the current motor current is greater than or equal to the specified maximum value for the motor current
or to actuate the electrically controllable valves in accordance with the closed operating mode of the compressed-air supply system when the current motor current is lower than the specified maximum value for the motor current.

A further aspect of the disclosure is a method for operating a compressor module. The method includes the steps of:
determining a target speed for the speed of the speed-controlled brushless electric motor in such a way that
   the target speed corresponds to a specified constant speed as long as the motor current I_{B} currently drawn by the speed-controlled brushless electric motor is lower than the specified maximum motor current (when I_{B}<I_{B max}) and
   the target speed is adjusted in such a way that the motor current I_{B} currently drawn by the speed-controlled brushless electric motor corresponds to the specified maximum motor current as long as the motor current currently drawn by the speed-controlled brushless electric motor corresponds at least approximately (that is, within the scope of control or adjustment precision) to the specified maximum motor current (n_{soll red}<n_{const} when I_{B}=I_{B max}).

The method preferably includes determining a reduced target speed value as a function of a pressure measured in the compressed-air supply system based on a stored characteristic curve or a stored characteristic diagram if the current mean motor current reaches the specified maximum motor current.

The disclosure allows the brushless direct-current motor to be configured for a constant speed as standard. According to the disclosure, exceeding the permissible current consumption (usually 35 A) of the compressor or compressing device is prevented by continuous or quasi-continuous adjustment of the target speed by way of the target speed being continuously or quasi-continuously adjusted when the permissible current consumption (that is, the specified maximum motor current) of the compressor or compressing device is reached such that the actually drawn motor current corresponds to the specified maximum motor current as long as this does not result in a target speed that is higher than the specified constant speed. For this purpose, the current consumption by the brushless electric motor for driving the compressor or compressing device is determined.

In a preferred embodiment, the compressed-air consumer is an air spring system of a vehicle, which has one or more bellows.

The compressor or compressing device is preferably combined with the brushless electric motor in the form of a compressor module to form one structural unit and thus these are firstly optimally coordinated with each other and secondly can be easily integrated into a compressed-air supply system as a unit.

The speed-controlled electric motor is preferably a speed-controlled BLDC motor, for which at least one target speed is specified during operation.

A further aspect relates to a method for operating a compressed-air supply system, in particular for a motor vehicle, including:
one or more compressed-air consumers,
compressed-air lines,
electrically controllable valves,
a compressed-air controller for actuating the electrically controllable valves,
a compressor module of the abovementioned type including a compressor or compressing device and a brushless electric motor as the drive, and
preferably a pressure reservoir.

According to this method, switchover from a closed operating mode to the open operating mode is performed when the motor current I_{B} drawn by the electric motor driving the compressor or compressing device reaches or exceeds the maximum motor current.

In addition or as an alternative, the operating method can evaluate a current signal, the value of which represents the value of the current motor current, and, in the event that the current motor current reaches the specified maximum motor current, determine a reduced target speed value in such a way that the motor current drawn by the speed-controlled electric motor driving the compressor or compressing device does not exceed the maximum motor current, but rather corresponds to the maximum motor current within the scope of control precision.

### BRIEF DESCRIPTION OF DRAWINGS

The invention will now be described with reference to the drawings wherein:

FIG. 1 shows a circuit diagram of an example of a compressed-air supply system together with a compressed-air consumer in the form of air springs of a vehicle;

FIGS. 2A and 2B show symbols for the valves shown in FIG. 1 for explaining their manner of operation;

FIG. 3 shows a schematic block diagram of an electronic compressed-air controller;

FIG. 4 shows a compressor module including a compressor, an electric motor and a motor electronics system;

FIG. 5 shows a sketch for illustrating the manner of operation of a brushless electric motor;

FIG. 6 shows graphs for illustrating the increase in the current consumption by a direct-current motor as the counterpressure increases;

FIG. 7 shows a symbolic representation of a compressor and a brushless electric motor driving it and including a motor electronics system; and,

FIG. 8 shows a graph for illustrating the target speed specification as a function of the motor current IB and the specified maximum motor current IB max.

### DETAILED DESCRIPTION

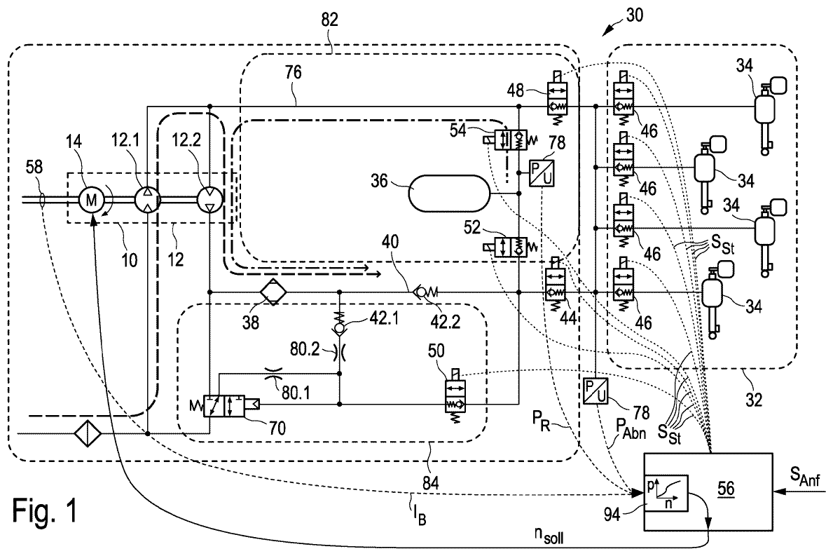

The compressed-air supply system 30 shown in FIG. 1 is used, for example, to supply compressed air to an air spring system 32 including a plurality of air springs 34 of a vehicle. Instead of an air spring system 32, other compressed-air consumers, for example a compressed-air brake system, can also be pneumatically connected to the compressed-air supply system 30.

The term “compressed-air consumer” is used herein both for an entire air spring system 32 or compressed-air brake system and for individual spring bellows 34 of an air spring system 32 or compressed-air brakes of a compressed-air brake system, thus for any form of compressed-air consumer.

Essential constituent parts of the compressed-air supply system 30 are, in addition to the compressed-air consumers 34, a compressor or compressing device 12 and its drive 14 and also electrically controllable valves 44, 46, 48, 50, 52 and 54 which can be controlled—that is, for example opened and closed—by a compressed-air controller 56. In this way, compressed air can be supplied to or discharged from the individual compressed-air consumers 34 in a targeted manner. The compressor work to be performed by the compressor 12 can differ greatly depending on which of the compressed-air consumers 34 has to be supplied with compressed air in the respective operating situation. The compressed-air controller 56 is an electronic controller which can output electrical control signals S1, S2, Sn for activation to the individual electrically controllable valves and thus control the compressed-air supply system 30.

For increased efficiency and constant availability, so-called “closed air spring systems” are used in passenger car air spring systems. These are air spring systems which can be operated, for example, with a compressed-air supply system 30, as shown in FIG. 1, because the compressed-air supply system 30 has components such as a pressure reservoir 36 which, in addition to an open operating mode, also allow a closed operating mode. In contrast to the “open systems” or an open operating mode, in the closed operating mode a reduction in the air mass in the air springs does not take place by discharging the excess air into the surrounding area, but rather this air is pumped into the pressure reservoir 36 by using the compressor 12. The compressor 12 required for this purpose is preferably configured for two-stage compression and driven by a BLDC motor 14. The closed operating mode by way of recirculation is performed via the second stage 12.2. In the open operating mode, the compressor 12 operates in two stages by pre-compression via the first stage 12.1 and final compression via the second stage 12.2.

In order to allow a closed operating mode, the compressed-air supply system 30 in the exemplary embodiment shown also has, in addition to the pressure reservoir 36, a return flow valve 48, a reservoir valve 52, a separation valve 44 and a boost valve 54.

The return flow valve 48 is pneumatically arranged between the compressed-air consumer 32 and the compressor 12 in such a way that compressed air can flow from the compressed-air consumer 32 into a boost and return flow line 76, which leads to the compressor 12, through the return flow valve 48 when it is activated—that is, opened.

The reservoir valve 52 is pneumatically arranged between the pressure reservoir and a pneumatic main pressure line 40 in such a way that compressed air can flow from the pressure reservoir 36 into the pneumatic main pressure line 40 through the reservoir valve 52 when it is activated—that is, opened.

The boost valve 54 is pneumatically arranged between the pressure reservoir 36 and a boost and return flow line 76 in such a way that compressed air can flow from the pressure reservoir 36 into the boost and return flow line 76, which leads to the compressor 12, through the boost valve 54 when it is activated—that is, opened. Thus, the compressor 12 can recompress the compressed air removed from the pressure reservoir 36 during closed operation, before it is supplied to the compressed-air consumer 32.

The separation valve 44 is pneumatically arranged between the main pressure line 40 and the air spring system 32 in such a way that compressed air can flow from the main pressure line 40 into the air spring system 32 through the separation valve 32 when it is activated—that is, opened.

Due to the required compressor capacity or the delivery capacity derived therefrom, the required torques for the driving compressor 12 in the closed operating mode differ significantly from the torque required for the open operating mode.

As already indicated, the compressed-air supply system 30 shown in FIG. 1 can be operated in an open operating mode or in a closed operating mode. In the open operating mode, outside air is drawn in from the surrounding area and compressed (see the dashed arrow in FIG. 1), and in the closed operating mode, air is extracted from a pressure vessel 36—also referred to as a reservoir here—and compressed (see the dash-dotted arrow in FIG. 1).

If the current consumption by the drive of the compressor—that is, the current consumption by the direct-current motor 14 (which is proportional to the required torque) during open operation is below approx. 25 A, it can increase to 50 A or more during closed operation. The closed operating mode is therefore the operating mode with the highest torque or current requirement. Both operating modes have to be provided in one vehicle.

### The Compressor Module

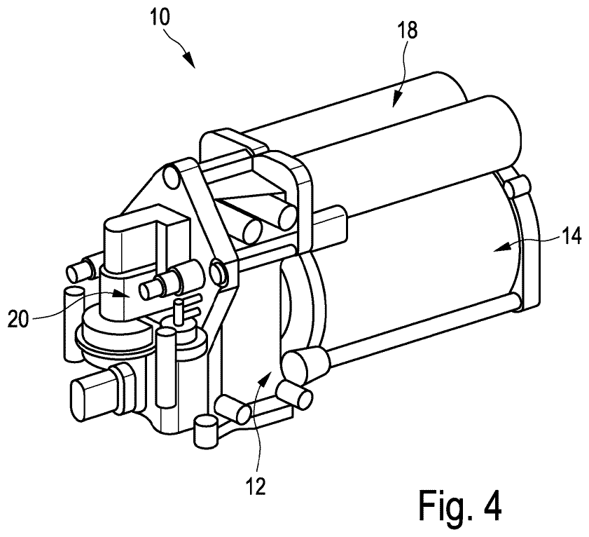

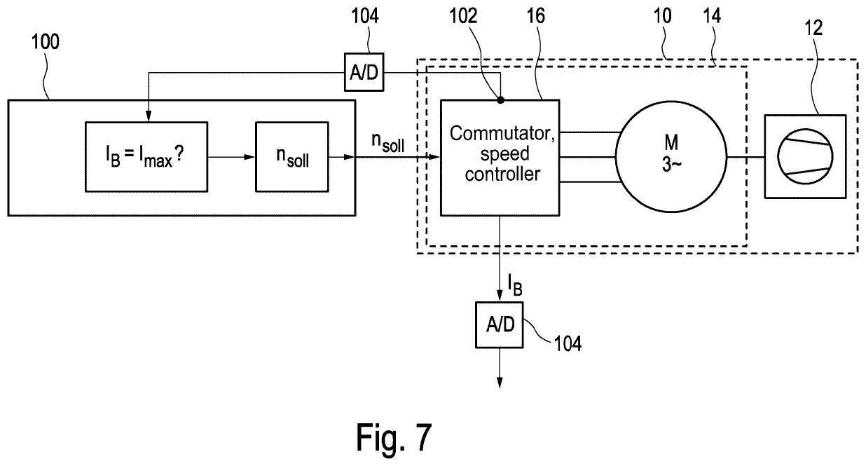

The compressor module 10 shown in FIG. 4 is provided for use in the compressed-air supply system 30, as illustrated by way of example in FIG. 1 with reference to a circuit diagram. The compressor module 10 is configured as a structural unit consisting of compressor 12, electric motor 14 and motor electronics system (16, see FIG. 7; not shown in FIG. 4; typically directly flange-connected to the electric motor 14) and also further components, such as air dryer 18 and air distributor 20 et cetera, for example.

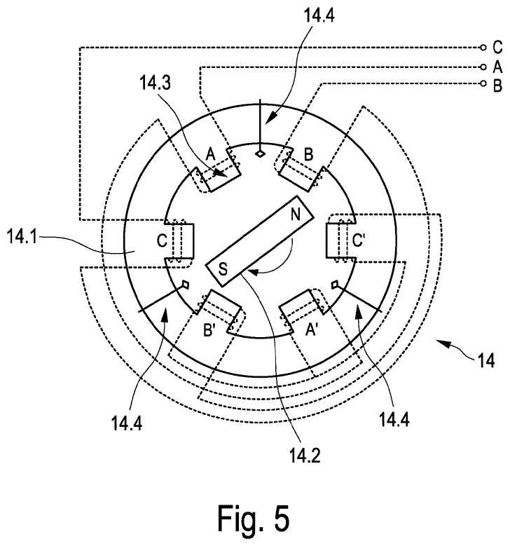

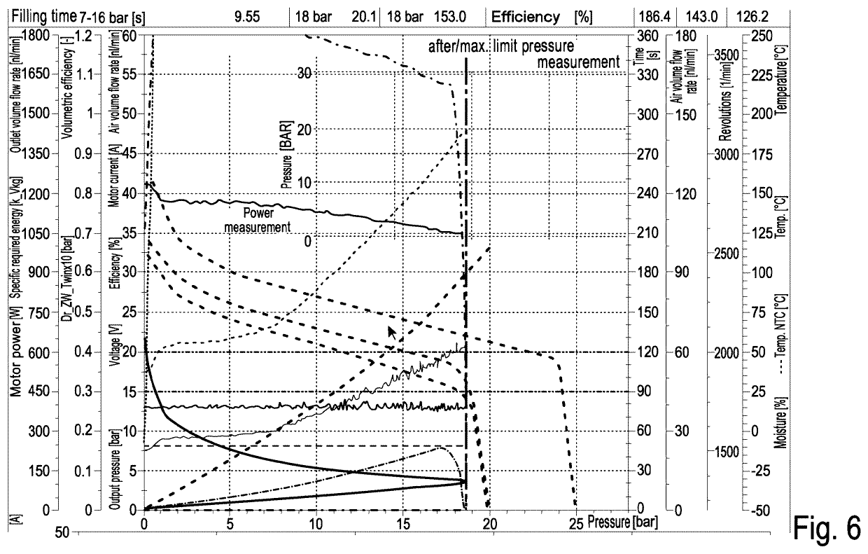

FIG. 5 shows a sketch of the stator and rotor of a brushless direct-current motor. The sketched brushless direct-current motor 14, as a so-called internal rotor motor, typically has a stator 14.1 fitted with electromagnetic coils, that is, a coil-wound stator, a rotor 14.2 fitted with permanent magnets, and a motor electronics system 16 (see FIG. 6). The motor electronics system 16 is configured as an electronic commutator in such a way that the motor electronics system 16 controls the current supply to the stator coils 14.3 of the stator 14.1 via circuit breakers and the connections A, B and C such that the stator coils 14.3 are in turn periodically supplied with current in such a way that a rotating magnetic field is produced, this causing synchronous rotation of the rotor 14.2 fitted with permanent magnets due to magnetic forces.

For speed control known per se of the brushless electric motor 14, the electric motor has means for rotor angle detection, for example a Hall sensor 14.4, for detecting the rotor position. This also allows a phase angle between the applied rotating field and the mechanical rotation of the rotor 14.2 to be detected and the phase angle of the rotating field to be correspondingly adjusted. The BLDC motor 14 therefore behaves similarly to a mechanically commutated direct-current motor. However, as a brushless direct-current motor, it is more efficient and subject to less wear and its speed can be controlled better than electric motors with a brush commutator.

In order to generate the rotating field by periodically energizing the stator coils 14.3 via the terminals A, B and C, the motor electronics system 16 is provided, which acts as an electronic commutator; see FIG. 7.

The speed of the electric motor 14 is also controlled in a manner known per se via the motor electronics system 16. For this purpose, a target speed nₛₒₗₗ is specified for the motor electronics system 16. In order to specify the target speed nₛₒₗₗ for the speed-controlled motor electronics system 16, an electronic control unit 100 is provided, which is supplied a value for the mean motor current by the motor electronics system 16 or which is connected to a current sensor 102, which detects the respective motor current received by the electric motor 12 during operation. The electronic control unit 100 may also be part of the motor electronics system 16 and is then at least indirectly connected to the current sensors 102 of the motor electronics system 16 in any case.

The current consumption by the electric motor 12 can be both calculated from the measured phase currents by the motor controller 16 and directly measured via the current sensor 58 or 102. In the first case, three current sensors 102 are required, which are necessary for operational safety in any case. In the second case, an extra current sensor 58 is necessary in the supply branch (see FIG. 1). The variant without a separate current sensor 58 is therefore preferred.

Compared to an unregulated direct-current motor, controlled, brushless direct-current motors have the advantage that their speed can be continuously controlled without any additional configuration effort. The brushless direct-current motor is commutated electronically, while a direct-current motor with a brush consumer system commutates mechanically.

For acoustic reasons, air spring systems require a constant speed over the entire specified load range (voltage, counterpressure and boost pressure, temperature, geodetic height), this endorsing the use of a controlled direct-current motor.

A disadvantage of the speed specification is that the request n=const results in a motor current which increases with the torque and which can also exceed the defined maximum limit of, for example, 35 A in the specific case. In order to maintain the maximum permissible current consumption, the compressing device would have to be configured in such a way that the current consumption is never exceeded under worst-case operating conditions within the specified applications. Such a scenario may be, for example, a laden vehicle, with twisted axles on rough terrain.

The disclosure now proposes configuring the motor for a constant speed as standard and reducing the necessary drive power of the compressor if there is a risk of the permissible current consumption (usually 35 A) being exceeded. For this purpose, a current consumption by the compressor, which is required to reach a target state of the compressed-air consumer, is predicted and, if there is a risk of the defined limit value being exceeded, a target speed and or an operating mode (open or closed), at which or in which the maximum motor current is not exceeded until the target state of the compressed-air consumer defined by the request signal is reached, is specified from the outset.

The pneumatic performance of a compressor for an air spring system is usually configured for the most common operating point. For example, a volume flow rate of 130 l/min is required at 11 bar boost pressure and 11 bar counterpressure. The maximum current consumption of 35 A, however, applies in all working ranges (operating and ambient pressures, voltages).

In order to not configuration the electric motor to be too large, it is configured for a current consumption of approx. 30 A at the specified operating point (taking into account device variations, service life influences, slightly higher operating loads). Particularly during pressure-charged operation, there is a sharp increase in the necessary drive power or the necessary current beyond 35 A (current˜torque) as the counterpressure increases.

In the example shown in FIG. 6, the current increases by more than 2 A per bar of counterpressure. A remedy would be to configuration the compressor module 10 in such a way that no excess currents occur at the defined, rather rare worst-case operating points. However, this has the disadvantage that the compressor module 10 exhibits correspondingly reduced, non-specification-compliant performance in the common operating ranges. A required delivery capacity of, for example, 130 l/min at 11 bar pre-pressure and 11 bar counterpressure cannot be achieved in this case. The problem is exacerbated by the device variation and service life influences. In order to avoid high currents, the speed of the BLDC motor can be reduced. Due to the proportionality of speed and current, however, this can result in an excessive, necessary speed reduction. If, for example, the current consumption is to be reduced from 60 A to 35 A, the speed would have to be reduced to 58% of the original speed, from for example 2850 min⁻¹ to below 1700 min⁻¹. This significant reduction in speed can lead to undesired effects in airborne and structure-borne noise.

One approach is to operate the BLDC motor at a constant speed and, in order to avoid overdimensioning the direct-current motor, to reduce this speed under certain load conditions (operating voltage and load). If the configuration is correct and all nominal conditions are correctly taken into account, the maximum current of, for example, 35 A is not exceeded. However, this requires all current-influencing factors, such as component tolerances, operating temperatures in the form of worst-case assumptions, to be taken into account and the resulting early switchover to a lower speed (including the resulting performance reduction) to be acceptable.

The aim was therefore not to configuration the compressor module for the rare worst-case conditions, but instead to provide a configuration in line with the most common operating conditions in combination with current limiting to ensure the specified current limits in combination with the situationally maximum compressor performance.

The requirement for constant compressor speed leads to an increasing current consumption as the compressor drive torque (which is proportional to the necessary motor torque) increases:

$$M \times 2 π \times n = η \times U \times I \qquad Formula$$

$$where :$$

$$M = compressor drive torque ( is constant at constant pressure )$$

$$n = compressor speed ( is kept constant in line with conventional control strategy in BLDC )$$

$$η = efficiency$$

$$U = supply voltage ( specified , between 9 V and 16 V as required )$$

$$I = motor current ( usually limited to 35 A )$$

Measurements have shown that the motor current consumption by a pressure-charged compressor for use in passenger car air spring systems can increase by more than 2 A/bar counterpressure. Therefore, when configured for the nominal point of 11 bar boost pressure and 11 bar counterpressure at |=30 A, only a counterpressure of up to 13.5 bar would be permissible (this then no longer covering the entire required operating range up to, for example, 18 bar). Further reductions may result from:
manufacturing-related device variation
running-in effects
wear
environmental conditions
self-heating

The compressor module is advantageously configured such that it can meet the majority of conditions of use with a single one of the specified target speeds. A predetermined, constant speed n_{const} is no longer specified as the target speed nₛₒₗₗ for the direct-current motor 14 only when, in special load cases, the specified maximum motor current I_{B max} is still reached. Instead, the target speed is adjusted in such a way that the drawn motor current I_{B} corresponds directly to the specified motor current I_{B max} (nₛₒₗₗ is variable, so that I_{B}=I_{B max}). The continuously adjusted and thus variable target speed is lower than the predetermined, constant target speed n_{const}. As soon as the adjusted, variable target speed increases to such an extent that it corresponds to the predetermined, constant speed n_{const} as the load decreases again, the predetermined, constant speed n_{const} is again specified as the target speed (nₛₑₜ=n_{const}). Here, the variable target speed is lower than the specified constant speed n_{const}.

The brushless electric motor 14 is therefore operated at the constant speed n_{const} as the target speed nₛₒₗₗ (nₛₒₗₗ=n_{const}) as long as the current motor current I_{B} is lower than the specified maximum motor current I_{B max}. As soon as the value for the current intensity of the current motor current I_{B} reaches or exceeds the specified maximum motor current I_{B max}, the current is limited, which results in the speed of the brushless electric motor decreasing, so that the load, that is, the torque to be delivered by the brushless electric motor, is so high that the specified maximum motor current I_{B max} IS not exceeded, the torque and thus the motor current can be kept constant.

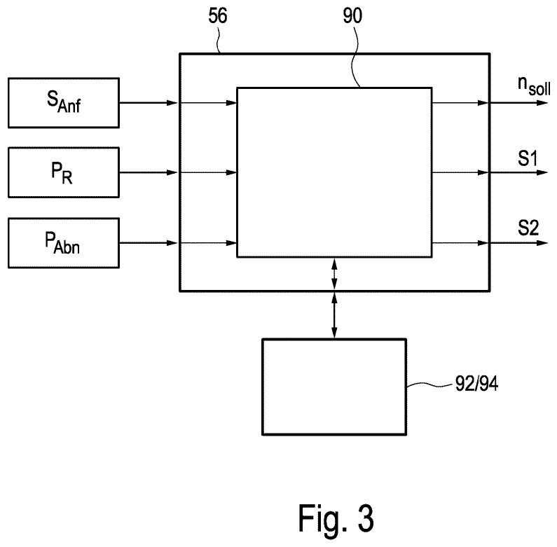

The brushless electric motor is preferably speed-controlled as long as the currently drawn motor current I_{B} is lower than or equal to the specified maximum motor current I_{B max}. The target speed then corresponds to a specified speed n_{const}-possibly one of several specified speeds. The specified target speed nₛₒₗₗ const is preferably stored in a target speed memory 92; see FIG. 3.

The compressed-air controller 56 is preferably configured to evaluate a current signal, the value of which represents the current motor current I_{B}, and, in the event that the current mean motor current reaches the specified maximum motor current I_{B max}, to determine a reduced target speed value n_{soll red} as a function of a pressure measured in the compressed-air supply system based on a stored characteristic curve or a stored characteristic diagram. For this purpose, the compressed air controller 56 is connected to or contains a characteristic diagram or characteristic curve memory 94 (see FIG. 3).

Control of the target speed as well as control of the motor current can be continuous, time-discrete or else quasi-continuous.

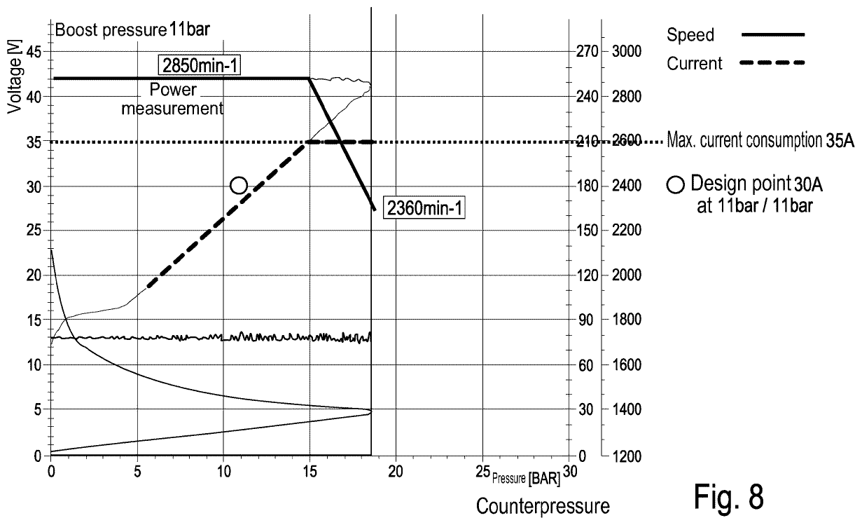

The result of such determination of the target speed nₛₒₗₗ for the direct-current motor 14 as a function of the current motor current I_{B} and the specified maximum motor current I_{B max} is shown in FIG. 8.

Furthermore, the basic configuration of the compressor 12 and the associated direct-current motor 14—that is, compressor module 10—should not be geared toward worst-case tolerance positions et cetera, when using the disclosure, but rather should also take place here in accordance with the nominal values.

Advantages arise in the event that the nominal widths on the compressor pressure side are temporarily too small (for example in the case of delivery in only one bellows 34) and an excessively high counterpressure builds up due to the high delivery volume flow rate, which would then in turn lead to an excessively high motor current.

The application of the control according to the disclosure of the target speed as well as the control of the motor current is not limited to compressors which are driven by a BLDC direct-current motor (even if the latter are preferred), but can also be extended to compressors with other direct-current motors.

### The Electronic Compressed-Air Controller

The compressed-air controller 56 outputs the control signals S_{St} for activating the electrically controllable valves—and thus for activating the open or closed operating mode—and a control signal nₛₒₗₗ for a target speed or one of several predetermined constant speeds n_{const} as a specification for the target speed of the direct-current motor 14; see FIG. 3. The compressed-air controller 56 can therefore switch over the compressed-air supply system from the closed to the open operating mode, or vice versa.

The compressed-air controller 56 can thus cause switchover to open operation, when the target speed of the direct-current motor 14 is already variably adjusted, because the motor current I_{B} has reached the maximum permissible motor current I_{B max}. Switchover to the open operating mode is preferably performed when the adjusted, variable target speed becomes too low and, for example, reaches or falls below a specified minimum target speed n_{soll min}.

In addition, the compressed-air controller 56 receives input signals which, as the pressure reservoir pressure signal PR, represent the value of the pressure in the pressure reservoir 36 and, as the pressure consumer pressure signal P_{Abn}, the value of the pressure in the compressed-air consumer 32 and also a request signal, which defines a target state of the compressed-air consumer 32—for example lifted or lowered—or the compressed-air supply system. Further possible input signals to the compressed-air controller 56 are a voltage signal, which represents the value of the available supply voltage, an ambient pressure signal, which represents the air pressure in the surrounding area, and/or an air temperature signal, which represents the air temperature in the surrounding area.

The pressure consumer pressure signal P_{Abn} can represent the pressure in the entire compressed-air consumer 32, that is, the air spring system 32 for example, or in the form of a vector with a plurality of components also the pressures in the individual bellows 34 of the air spring system 32.

The following text first describes how compressed air can be supplied to the compressed-air consumer 32, that is, the air spring system 32 of a vehicle for example, in the open or in the closed operating mode. This is necessary, for example, if the vehicle is to be lifted on one side or on all sides. For this lifting operation, compressed air has to be supplied to the bellows 34.

### Open Operating Mode

Both the lifting and lowering operations can be performed in the closed operating mode in an air spring system.

In the first open operating mode, for example for lifting the air spring system 12, compressed air is passed from the compressor 12 to the compressed-air consumer 32—that is, the air spring system 32—via a pneumatic main pressure line 40 for the compressed-air supply of the compressed-air consumer 32. Within the air spring system 32, the compressed air is distributed via individual pressure consumer valves 46—which are bellows valves 46 of spring bellows 34 of the air spring system 32 in the exemplary embodiment shown.

In the exemplary embodiment shown, the compressor 12 is configured in two stages and has a first compressor stage 12.1 and a second compressor stage 12.2. In the open operating mode, the outside air is thus, in two stages, first pre-compressed via the first compressor stage 12.1 and then re-compressed via the second compressor stage 12.2.

The compressed air provided in the open operating mode by the compressor 12 can also be supplied to a pressure reservoir 36 instead of a compressed-air consumer 32, in order to thus create the prerequisite for a closed operating mode.

Therefore, a compressor, such as compressor 12, and a pneumatic main pressure line 40, which feeds compressed air provided by the compressor 12 to the compressed-air consumer 32, are required for the compressed-air supply in the open operating mode. Further components, such as an air dryer 38 or an isolating or separation valve 44, are optional.

In the second open operating mode, for example when lowering the air spring system 12, the outlet valve is opened. This opening of the outlet valve 50 causes the pneumatically controlled 3/2-way valve 70 to be moved to the working position in which venting takes place. After opening the outlet valve 50, the pressure of the air to be vented acts as a control pressure, which acts on a control piston 74 of the pneumatically controlled 3/2-way valve 70 and moves the 3/2-way valve 70 against the force of its return spring 72 to the working position. Throttles 80.1 and 80.2 and also two non-return or one-way valves 42.1 and 42.2 provide expedient limiting of the control pressure for actuating the pneumatically controlled 3/2-way valve 70.

### Closed Operating Mode

Both the lifting and lowering operations can be performed in the closed operating mode in an air spring system. In general, this means that a compressed-air consumer 32 can be supplied with compressed air in a first closed operating mode and can discharge air in a second closed operating mode—also referred to as the reflow mode.

For the closed operating mode, a pressure reservoir 36, for example configured as a compressed-air vessel, a reservoir valve 52, an optional boost valve 54 and a likewise optional separation valve 44 and a likewise optional return flow valve 48 and also corresponding compressed-air lines are additionally provided. The components for the closed operating mode, which are not required for the open operating mode, —namely the pressure reservoir 36, the reservoir valve 52, the optional boost valve 54 and the return valve 48—are shown in FIG. 1 within the dashed border 82.

In the first closed operating mode, for example for lifting an air spring system, air is pumped from the pressure reservoir 36 to the air spring system 32 and into its spring bellows 34 via the compressor 12 and its second compressor stage 12.2. For this purpose, the compressor 12, the boost valve 54 and the separation valve 44 are activated and the bellows valves 46 are opened. In this way, a vehicle can be lifted via the air spring system 32 in the closed operating mode of the compressed-air supply system 30 (“boost”). Since the air in the pressure vessel 36 is already at a higher static pressure than the outside air in the surrounding area, the air is, in the closed operating mode, re-compressed only via the second stage 12.2 of the compressor 12 and the first stage 12.1 of the compressor 12 is pneumatically ineffective in this case.

Just like in the open operating mode, the compressed air is, in the closed operating mode, also fed via the air dryer 38 of the pneumatic main pressure line 40 to and through the one-way or non-return valve 42.2 and thus provided for delivery to a compressed-air consumer 32.

In the second closed operating mode, for example when lowering an air spring system, air is pumped from the bellows 34 into the pressure reservoir 36. Here, the compressor 12 is activated and both the return flow valve 48 and the reservoir valve 52 are opened, that is, activated. Air is then pumped from the bellows 36, through the return flow valve 48, via the second stage 12.2 of the compressor 12, through the reservoir valve 52, into the pressure reservoir 36.

Distribution of Compressed Air within the Compressed-Air Consumer

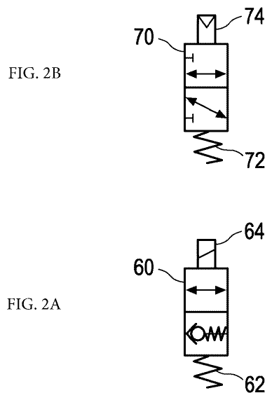

The delivery of the compressed air to the compressed-air consumer or consumers 32 or the pressure reservoir 36 and also the distribution of the compressed air within the compressed-air consumer 32—in the case of the example between the air springs 34 of the air spring system 32—is performed via electrically actuated 2/2-way valves 46, one of which is also shown in FIG. 2A as 2/2-way valve 60. In their first (rest) position caused via a return spring 62, the 2/2-way valves 46 act as a one-way or non-return valve. In the actuated second (activated or working) position, the 2/2-way valves 46 are opened. The electrically actuable 2/2-way valves 46 are connected to an electronic compressed-air controller 56, which can be identical to an electronic control unit for controlling the compressor module 10 and can actuate control solenoids 64 of the 2/2-way valves 46. The 2/2-way valves 46 of the compressed-air consumer 32—that is, in the case of the example the air spring system 32—correspond to the 2/2-way valve 60 shown in FIG. 2A.

### Venting

Irrespective of whether the compressed-air supply system 30 is operated in the open or closed operating mode, venting of one or more components—such as the spring bellows 34 for example—of the compressed-air consumer 32 may be necessary. In the case of a vehicle with an air spring system, one or more bellows 36 of the air spring system has to be vented if the vehicle is to be lowered on one side or on all sides.

The compressed-air consumer 32—for example when lowering the vehicle with an air spring system—can also be vented in the open or in the closed operating mode. These variants for venting of the compressed-air consumer 32 will be explained in more detail below. Both cases involve venting the compressed-air consumer 32—that is, not venting the compressed-air supply system 30 as a whole. The compressed-air supply system 30 is necessarily vented during open operation in which air is discharged from the compressed-air supply system 30 into the surrounding area.\

### Venting During Open Operation

In the case of the example shown, the compressed-air supply system 30 is configured as an indirectly venting compressed-air supply system for venting in the open operating mode.

Here, an outlet valve 50, a pneumatically controlled 3/2-way valve 70, throttles 80.1 and 80.2 and also a further non-return or one-way valve 42.1 are provided for this purpose-see the corresponding border 84 around the components for indirect venting in FIG. 1.

Venting of the compressed-air supply system 30 and one or more compressed-air consumers 32 can be caused in the open operating mode by opening the outlet valve 50, which is also configured as an electrically actuated 2/2-way valve. Opening the outlet valve 50 causes the pneumatically controlled 3/2-way valve 70, as is also shown in FIG. 2B, to be moved to the working position. The working position is the position in which venting is performed. After opening the outlet valve 50, the pressure of the air to be vented acts as a control pressure, which acts on a control piston 74, which moves the 3/2-way valve 70 against the force of its return spring 72 to the working position. Throttles 80.1 and 80.2 and also two non-return or one-way valves 42.1 and 42.2 provide expedient limiting of the control pressure for actuating the pneumatically controlled 3/2-way valve 70.

### Venting During Closed Operation

In the closed operating mode, the components of the compressed-air consumer 32 are vented into the pressure vessel 36.

During venting in the closed operating mode, the air from the bellows 34 is pumped into the pressure reservoir 36 via the compressor 12 and its second compressor stage 12.2. For this purpose, the compressor 12 is activated and the return flow valve 48 and also the reservoir valve 52 are opened. Thus, for example, the air spring system 32 can be lowered in the closed operating mode. In this case, the first stage 12.1 of the compressor 12 is pneumatically ineffective.

### Combination of Open/Closed Operating Mode

An open operating mode exists when:
the compressor 12 delivers air directly from the surrounding area into the compressed-air consumers 34, for example the bellows 34 of the air spring system 32; then the compressor 12 is activated, the separation valve 44 is activated and the bellows valves 46 are activated=>“Lift” request
the compressor 12 fills the compressed-air reservoir 36 from the surrounding area; then the compressor 12 is activated and the reservoir valve 52 is activated=>“Fill reservoir” request
the air is vented from the compressed-air consumers 34 (in the example: the bellows 34 of the air spring system 32) into the atmosphere (bellows valves activated, separation valve activated, outlet valve activated)=> “Lower” request in the atmosphere.

A closed operating mode exists when:
the air from the bellows 34 is pumped into the pressure reservoir 36; then the compressor 12 is activated, the return flow valve 48 is activated, the reservoir valve 52 is activated=> “Lower” request in closed operating mode (“reflow”). In this case, the first stage 12.1 of the compressor 12 is pneumatically ineffective.

The air is pumped from pressure reservoir 36 into bellows 34; then compressor 12 is activated, boost valve 54 is activated, the separation valve 44 is activated, the bellows valves 46 are activated=> “Lift” request in the closed operating mode (“boost”). In this case, the first stage 12.1 of the compressor 12 is pneumatically ineffective.

It is understood that the foregoing description is that of the preferred embodiments of the invention and that various changes and modifications may be made thereto without departing from the spirit and scope of the invention as defined in the appended claims.

### LIST OF REFERENCE NUMERALS

10 Compressor module
12 Compressor
12.1 First compressor stage
12.2 Second compressor stage
14 Electric motor
14.1 Stator
14.2 Rotor
14.3 Stator coil
14.4 Hall sensor
16 Motor electronics system
18 Air dryer
20 Air distributor
30 Compressed-air supply system
32 Air spring system
34 Bellows of the air springs
36 Pressure reservoir
38 Air dryer
40 Main pressure line
42 One-way valve/non-return valve
44 Separation valve (electrically controlled)
46 Pressure consumer valve (bellows valve, electrically controlled)
48 Return flow valve (electrically controlled)
50 Outlet valve (exhaust valve, electrically controlled)
52 Reservoir valve (electrically controlled)
54 Boost valve (electrically controlled)
56 Compressed-air controller
58 Current sensor
60 2/2-way valve
62 Return spring
64 Control magnet
70 3/2-way valve (pneumatically controlled) for venting
72 Return spring
74 Control piston
76 Boost and return flow line
78 Pressure sensor; P/U converter
80 Throttle
82 Components for closed operation
84 Components for indirect venting
90 Evaluation unit
92 Memory containing specified target speeds
94 Characteristic curve memory
100 Control unit
102 Current sensor
104 Analog-to-digital converter

1. A compressor module comprising:
a compressor;
a speed-controlled brushless electric motor for driving said compressor, wherein a motor current is produced during operation of said speed-controlled brushless electric motor;
said speed-controlled brushless electric motor having a motor electronics system with an electronic commutator and a speed controller being assigned to said speed-controlled brushless electric motor, wherein a speed is controlled on a basis of a specified target speed during operation;
the compressor module being connected to or having an electronic control unit configured to specify the target speed as a function of the motor current currently drawn by said speed-controlled brushless electric motor and a specified maximum motor current such that:
the target speed corresponds to a specified constant speed as long as the motor current currently drawn by said speed-controlled brushless electric motor is lower than the specified maximum motor current; and,
the target speed is adjusted such that the motor current currently drawn by said speed-controlled brushless electric motor corresponds to the specified maximum motor current as long as the motor current currently drawn by said speed-controlled brushless electric motor corresponds at least approximately to the specified maximum motor current.

2. The compressor module of claim 1, wherein the electronic control unit is configured to continuously adjust a value for the target speed in a load-dependent manner in accordance with a specified characteristic curve or a specified characteristic diagram when a mean of the currently drawn motor current reaches the specified maximum motor current.

3. The compressor module of claim 2, wherein the electronic control unit is configured to continuously adjust the value for the target speed in accordance with the specified characteristic curve or the specified characteristic diagram as a function of a pressure measured in a compressed-air supply system.

4. The compressor module of claim 2 further comprising: a characteristic curve memory or a characteristic diagram memory, which is connected to the electronic control unit and in which a characteristic curve or a characteristic diagram is stored, the characteristic diagram representing values for the target speed as a function of a pressure value as an input value for the characteristic curve or the characteristic diagram.

5. The compressor module of claim 1, wherein the compressor module is for a compressed-air supply system of a vehicle.

6. A compressed-air supply system comprising:
at least one compressed-air consumer;
a plurality of compressed-air lines;
a plurality of electrically controllable valves;
a compressed-air controller for actuating said plurality of electrically controllable valves;
a compressor module including a compressor and a speed-controlled brushless electric motor for driving said compressor, wherein a motor current is produced during operation of said speed-controlled brushless electric motor;
said speed-controlled brushless electric motor having a motor electronics system with an electronic commutator and a speed controller being assigned to said speed-controlled brushless electric motor, wherein a speed is controlled on a basis of a specified target speed during operation;
said compressor module being connected to or having an electronic control unit configured to specify the target speed as a function of the motor current currently drawn by said speed-controlled brushless electric motor and a specified maximum motor current such that:
the target speed corresponds to a specified constant speed as long as the motor current currently drawn by said speed-controlled brushless electric motor is lower than the specified maximum motor current; and,
the target speed is adjusted such that the motor current currently drawn by said speed-controlled brushless electric motor corresponds to the specified maximum motor current as long as the motor current currently drawn by said speed-controlled brushless electric motor corresponds at least approximately to the specified maximum motor current;
a compressed-air reservoir;
said at least one compressed-air consumer is or is configured to be pneumatically connected to at least one of said compressor and said compressed-air reservoir via said plurality of compressed-air lines and said plurality of electrically controllable valves such that the compressed-air supply system is operable either with open operation or with closed operation;
said compressed-air controller being configured:
to evaluate a current signal, the value of which represents the value of the current motor current, and, in an event that the current motor current reaches the specified maximum motor current, to determine a reduced target speed value such that the motor current drawn by said speed-controlled brushless electric motor driving said compressor does not exceed the maximum motor current, but rather corresponds to the maximum motor current within a scope of control precision.

7. The compressed-air supply system of claim 6 further comprising at least one pressure sensor connected to the electronic control unit of the compressor module and configured to provide an input value for characteristic curve control or characteristic diagram control of the target speed of said speed-controlled brushless electric motor for driving said compressor by the electronic control unit.

8. The compressed-air supply system of claim 6, wherein said compressed-air controller is configured:
to actuate said plurality of electrically controllable valves in accordance with the open operation of the compressed-air supply system when the adjusted, variable target speed reaches or falls below a specified minimum target speed; or,
to actuate the electrically controllable valves in accordance with the closed operation of the compressed-air supply system as long as the adjusted, variable target speed exceeds the specified minimum target speed.

9. The compressed-air supply system of claim 8, wherein said compressed-air controller is configured to specify, after switchover to the open operation of the compressed-air supply system, the target speed as a function of the motor current currently drawn by said speed-controlled brushless electric motor and the specified maximum motor current such that the target speed corresponds to a specified constant speed as long as the motor current currently drawn by said speed-controlled brushless electric motor is lower than the specified maximum motor current.

10. The compressed-air supply system of claim 6, wherein the compressed-air supply system is for a motor vehicle.

11. A method for operating a compressor module, the compressor module including a compressor and a speed-controlled brushless electric motor for driving the compressor, wherein a motor current is produced during operation of the speed-controlled brushless electric motor; the speed-controlled brushless electric motor having a motor electronics system with an electronic commutator and a speed controller being assigned to the speed-controlled brushless electric motor, wherein a speed is controlled on a basis of a specified target speed during operation; the compressor module being connected to or having an electronic control unit configured to specify the target speed as a function of the motor current currently drawn by the speed-controlled brushless electric motor and a specified maximum motor current, the method comprising:
determining a target speed for the speed of the speed-controlled brushless electric motor such that:
the target speed corresponds to a specified constant speed as long as the motor current currently drawn by the speed-controlled brushless electric motor is lower than the specified maximum motor current and
the target speed is adjusted in such a way that the motor current currently drawn by the speed-controlled brushless electric motor corresponds to the specified maximum motor current as long as the motor current currently drawn by the speed-controlled brushless electric motor corresponds to the specified maximum motor current within a scope of control and adjustment precision.

12. The method of claim 11 further comprising determining a reduced target speed value as a function of a pressure measured in the compressed-air supply system based on a stored characteristic curve or a stored characteristic diagram when a mean of the motor current reaches the specified maximum motor current.

13. A method for operating a compressed-air supply system having at least one compressed-air consumer, a plurality of compressed-air lines, a plurality of electrically controllable valves, a compressed-air controller for actuating the plurality of electrically controllable valves, and a compressor module including a compressor and a speed-controlled brushless electric motor for driving the compressor, wherein a motor current is produced during operation of the speed-controlled brushless electric motor; the speed-controlled brushless electric motor having a motor electronics system with an electronic commutator and a speed controller being assigned to the speed-controlled brushless electric motor, wherein a speed is controlled on a basis of a specified target speed during operation; the compressor module being connected to or having an electronic control unit configured to specify the target speed as a function of the motor current currently drawn by the speed-controlled brushless electric motor and a specified maximum motor current such that:
the target speed corresponds to a specified constant speed as long as the motor current currently drawn by the speed-controlled brushless electric motor is lower than the specified maximum motor current; and,
the target speed is adjusted such that the motor current currently drawn by the speed-controlled brushless electric motor corresponds to the specified maximum motor current as long as the motor current currently drawn by the speed-controlled brushless electric motor corresponds at least approximately to the specified maximum motor current;
the compressed-air supply system further having a compressed-air reservoir, wherein the at least one compressed-air consumer is or is configured to be pneumatically connected to at least one of the compressor and the compressed-air reservoir via the plurality of compressed-air lines and the plurality of electrically controllable valves such that the compressed-air supply system is operable either with open operation or with closed operation; the method comprising:
evaluating a current signal, the value of which represents the value of the current motor current, and,
in an event that the current motor current reaches the specified maximum motor current, determining a reduced target speed value such that the motor current drawn by the speed-controlled electric motor driving the compressor does not exceed the maximum motor current, but rather corresponds to the maximum motor current within the scope of control precision.

14. The method of claim 13 further comprising switching over from the closed operation to the open operation when the adjusted, variable target speed reaches or falls below a specified minimum target speed.
